(19) United States
(12) Patent Application Publication
(10) Pub. No.: US 2025/0103256 A1
(43) Pub. Date: Mar. 27, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: KOJI YASUZAKI, Saitama (JP); NAOYA WATANABE, Tokyo (JP)

(21) Appl. No.: 18/887,804

(22) Filed: Sep. 17, 2024

(30) Foreign Application Priority Data
Sep. 26, 2023 (JP) 2023-162671

(51) Int. Cl. G06F 3/12

(52) U.S. Cl. CPC G06F 3/1245; G06F 3/1205

(57) ABSTRACT

An information processing apparatus connected to an image forming apparatus includes a determination unit for determining whether pieces of setting information respectively set to a plurality of pieces of image data included in a same page to be printed by the image forming apparatus are common, and a control unit for converting at least a part of the pieces of image data in the plurality of pieces of image data, in a case where the determination unit determines that the pieces of setting information respectively set to the plurality of pieces of image data are not common.

### BACKGROUND

### Field

The present disclosure relates to an information processing apparatus, an information processing method, and a storage medium.

### Description of the Related Art

Japanese Patent Application Laid-open No. 2012-136001 discusses a method of printing, in a case where a plurality of images with different print settings is input and the plurality of images are printed at the same time, one of the print settings are disabled to perform printing.

However, the method in Japanese Patent Application Laid-open No. 2012-136001 is seen to discuss that when one of the print settings is canceled to perform printing, an image with the print setting disabled cannot appropriately be printed.

### SUMMARY

According to an aspect of the present disclosure, an information processing apparatus connected to an image forming apparatus includes a determination unit configured to determine whether pieces of setting information respectively set to a plurality of pieces of image data included in a same page to be printed by the image forming apparatus are common, and a control unit configured to convert at least a part of the pieces of image data in the plurality of pieces of image data, in a case where the determination unit determines that the pieces of setting information respectively set to the plurality of pieces of image data are not common.

Further features of the present disclosure will become apparent from the following description of exemplary embodiments with reference to the attached drawings.

### BRIEF DESCRIPTION OF THE DRAWINGS

FIG. 1 is a configuration diagram illustrating an image forming apparatus according to a first exemplary embodiment.

FIG. 2 is a functional block diagram of the image forming apparatus according to the first exemplary embodiment.

FIG. 3 is a flowchart illustrating a basic printing procedure according to the first exemplary embodiment.

FIG. 4A is a block diagram illustrating a hardware configuration of an information processing apparatus according to the first exemplary embodiment. FIG. 4B is a block diagram illustrating a software configuration of a print layout application according to the first exemplary embodiment.

FIGS. 5A and 5B are diagrams each illustrating a setting user interface (UI) screen of the print layout application according to the first exemplary embodiment.

FIGS. 6A to 6E are diagrams illustrating a data conversion method of white image data according to the first exemplary embodiment.

FIG. 7 is a graph illustrating a relationship in a value conversion of the white image data according to the first exemplary embodiment.

FIG. 8 is a flowchart illustrating a procedure of print layout processing according to the first exemplary embodiment.

FIGS. 9A to 9E are diagrams illustrating a data conversion method of white image data according to a second exemplary embodiment.

FIG. 10 is a flowchart illustrating a procedure of print layout processing according to the second exemplary embodiment.

### DESCRIPTION OF THE EMBODIMENTS

Hereinbelow, exemplary embodiments of the present disclosure will be described with reference to the attached drawings. The following exemplary embodiments are not intended to limit the present disclosure related to the scope of the claims, and all of the combinations of features described in the exemplary embodiments are not necessarily essential.

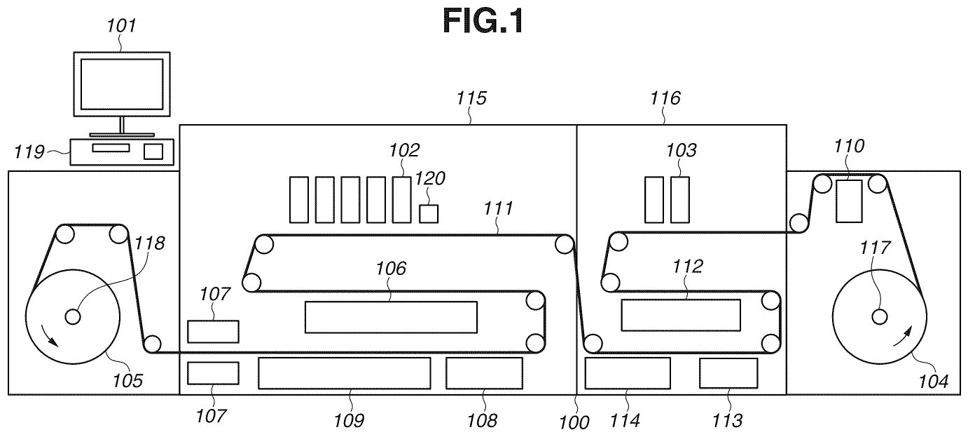

A configuration of an image forming apparatus according to a first exemplary embodiment will now be described. FIG. 1 illustrates an example of a schematic configuration of an image forming apparatus 100 according to the present exemplary embodiment. The image forming apparatus 100 is an apparatus for forming an image on a continuous print medium (hereinbelow, referred to as roll paper) 111 on which continuous image forming used in the present exemplary embodiment is possible. In the present exemplary embodiment, the image forming apparatus 100 includes a paper feed device 104 for feeding the roll paper 111, and a recording unit 116 for performing spot color printing. The image forming apparatus 100 also includes a recording unit 115 for performing basic color printing, a wind-up device 105 for winding up the roll paper 111, and a user interface (UI) operation panel 101. The paper feed device 104 is a device for feeding the roll paper 111 to the image forming apparatus 100. The paper feed device 104 rotates a paper tube of the roll paper 111 around a rotation shaft 117 to feed the roll paper 111 wound around the paper tube to the image forming apparatus 100 at a constant speed via a plurality of rollers, such as a conveyance roller and a sheet feed roller. The wind-up device 105 is a device for winding up the roll paper 111 conveyed from the image forming apparatus 100 in a roll shape around a paper tube of the wind-up device 105. The paper tube is attached to a rotation shaft 118, and winds up the roll paper 111 conveyed to the paper tube at a predetermined speed as a print product, via a plurality of rollers, such as a conveyance roller and a discharge roller, by rotating the paper tube around the rotation shaft 118. The print product is wound around the paper tube and held in a roll shape. Before printing begins, the roll paper 111 is passed through from the paper feed device 104 to the wind-up device 105. The roll paper 111 is set on the paper feed device 104 and a leading end of the roll paper 111 is passed through an upper side of a skew correction apparatus 110. The roll paper 111 is then passed through a lower side of the printing device 103 of the recording unit 116.

The printing device 103 in the present exemplary embodiment is a device for performing printing using a specific color ink, such as a white ink, other than color inks such as cyan (C), magenta (M), yellow (Y), and black (K) (i.e., CMYK) inks. The printing device 103 according to the present exemplary embodiment prints a white image based on binary white image data. The roll paper 111 is passed through the lower side of a drying device 112, and the upper sides of cooling devices 113 and 114. The roll paper 111 is then passed through the lower sides of a mark detection sensor 120 and a printing device 102 of the recording unit 115, the upper side of a drying device 106, and the upper sides of cooling devices 108 and 109. In the present exemplary embodiment, the mark detection sensor 120 is used to perform alignment when an image by the printing device 102 is formed on an image generated by the printing device 103. This configuration is not seen to be limiting, and a scanner device can be used.

The printing device 102 of the present exemplary embodiment is a device for performing printing using print basic colors (CMYK) based on binary CMYK image data (color image data). The roll paper 111 is wound on the wind-up device 105 after passing between connection scanner devices 107. After the roll paper 111 is passed in the image forming apparatus 100, a user inputs a print job to a control personal computer (PC) 119 serving as a print control device for controlling the image forming apparatus 100.

After inputting the print job, the user selects a print start button on the UI operation panel 101 to start printing. The printed image is read by the scanner devices 107, and the control PC 119 analyzes the image read by the scanner devices 107, to check whether the printed product has defects. The control PC 119 can also perform editing processing of the input print job.

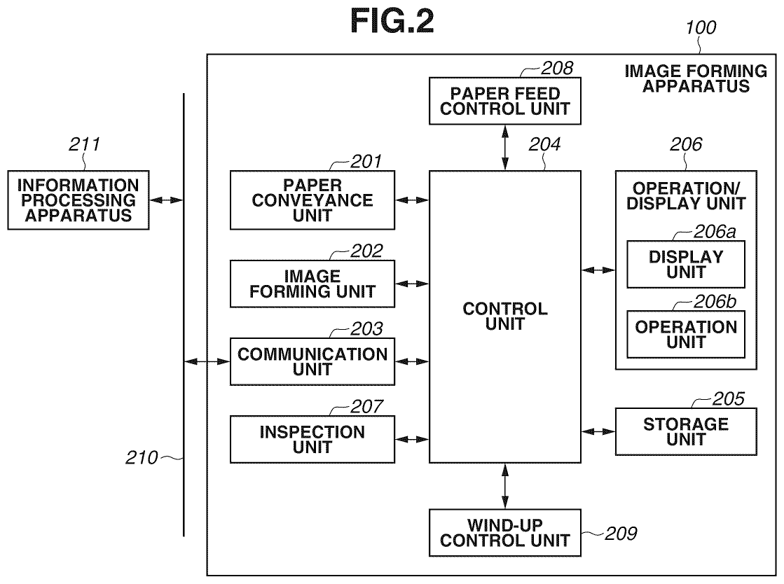

Next, a control configuration of the image forming apparatus 100 will be described in detail. FIG. 2 is a functional block diagram illustrating the control configuration of the image forming apparatus 100. As illustrated in FIG. 2, the image forming apparatus 100 includes a paper conveyance unit 201, an image forming unit 202, a communication unit 203, a control unit 204, a storage unit 205, an operation/display unit 206, an inspection unit 207, a paper feed control unit 208, and a wind-up control unit 209.

The paper conveyance unit 201 is a conveyance mechanism for the roll paper 111 disposed inside the image forming apparatus 100. The paper conveyance unit 201 conveys the roll paper 111 conveyed from the paper feed control unit 208 using the plurality of rollers to the image forming unit 202, and conveys the roll paper 111 having passed the image forming unit 202 to the wind-up control unit 209. The image forming unit 202 forms an image on the roll paper 111 fed from the paper feed control unit 208 based on the print data instructed to be printed. The image forming unit 202 conveys the roll paper 111 with the image formed thereon toward the wind-up control unit 209. The communication unit 203 configuration includes a communication control card, such as a local area network (LAN) card. The communication unit 203 transmits and receives various kinds of data to and from an information processing apparatus 211 (e.g., PC) connected to a communication network 210, such as a LAN and a wide area network (WAN). The information processing apparatus 211 includes a print application and the like to be used for printing.

The control unit 204 includes, for example, a central processing unit (CPU) and a random access memory (RAM). The CPU of the control unit 204 reads out various kinds of programs, such as a system program and a processing program, stored in the storage unit 205, and loads the read programs in the RAM to execute various kinds of processing based on the loaded programs. The control unit 204 can perform image forming processing to execute an image forming job (hereinbelow, referred to as a job) in response to a user's instruction. The storage unit 205 is composed of, for example, a nonvolatile semiconductor memory so-called flash memory or a hard disk drive (HDD). The storage unit 205 stores various kinds of programs including a system program and a processing program to be executed by the control unit 204, and various kinds of data required for executing these programs. The operation/display unit 206 is for example, a liquid crystal display (LCD) with a touch-panel attached thereto, and includes a display unit 206a and an operation unit 206b. The display unit 206a displays various kinds of information on a display screen based on a display control signal input from the control unit 204. The operation unit 206b includes various kinds of operation keys, such as numeric keypads and a start key, to receive various kinds of input operations from a user, and outputs operation signals to the control unit 204. The operation/display unit 206 is used, for example, for setting job information when a job is executed. A user can set information regarding paper to be used and a print speed, and conditions regarding the number of sheets to be printed, the number of copies to be printed, a printing length, or a printing diameter.

Next, operations in a case where the image forming apparatus 100 performs image forming processing on the roll paper 111 will be described. First, a user generates data of a print job including multi-valued white image data and color image data using a print layout application (imposition application) on the information processing apparatus 211, performs print settings of the job and the number of delivery rolls, and transmits these pieces of information to the image forming apparatus 100 via the communication network 210. The control unit 204 of the image forming apparatus 100 receives the job data transmitted from the information processing apparatus 211 via the communication unit 203, and a job ticket including the print setting information of the job, the information about the number of delivery rolls, and the like. The inspection unit 207 is a device for checking whether printing is performed on a printed image sheet without discharge defects. The control unit 204 prints a detection pattern for a discharge defect inspection, the inspection unit 207 checks whether the printed image includes discharge defects by the scanner reading the detection pattern. In a case where the inspection unit 207 detects the discharge defects, the control unit 204 stops the image forming apparatus 100. There are various kinds of inspection methods, such as a method of printing a detection pattern and reading it by a scanner, a method of directly reading a printed image by a camera or a scanner, or a method of observing a discharging state from nozzles. In the present exemplary embodiment, the image forming apparatus 100 uses the method of printing a detection pattern and reading it with a scanner to check whether discharge defects are present.

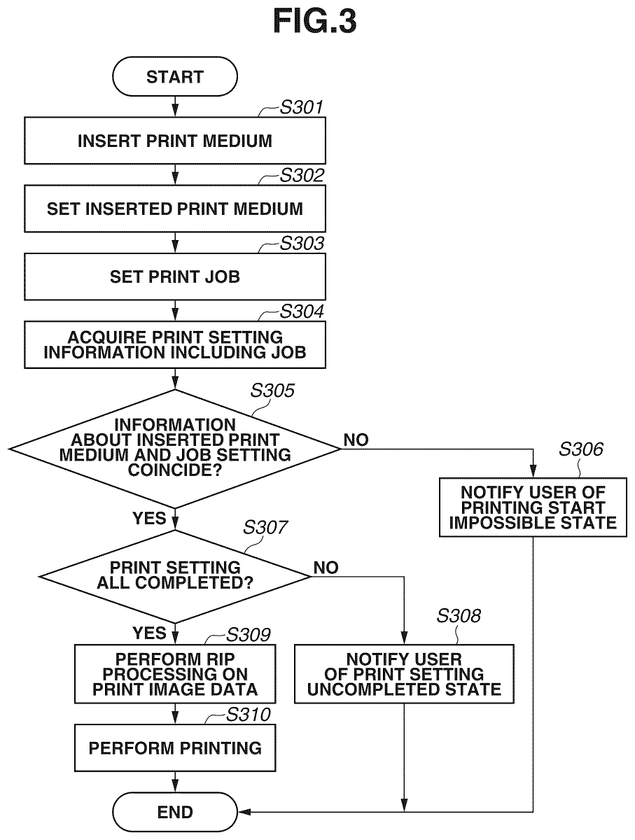

Next, a flowchart illustrating a basic procedure of printing processing of the image forming apparatus 100 will be described. FIG. 3 is a printing flowchart, illustrating a basic procedure from inserting a print medium into the image forming apparatus 100 for printing. In the processing of the present flowchart, the CPU of the control unit 204 reads out various kinds of programs, such as a system program and a processing program, stored in the storage unit 205, and loads the programs in the RAM to execute various kinds of processing based on the loaded programs.

In step S301, a print medium is inserted into the paper feed device 104 of the image forming apparatus 100. In the present exemplary embodiment, the print medium is wound in a roll shape. The print medium wound in a roll shape is pulled out along a path of the conveyance mechanism of the image forming apparatus 100 via the plurality of conveyance rollers, and is fixed to a wind-up core attached to the wind-up device 105, which is an end of the conveyance path. In step S302, before starting the print processing, a user makes a setting of a print medium inserted into the image forming apparatus 100. This setting is made by designating a print medium from the print media registered in the image forming apparatus 100 in advance. This enables setting a most suitable conveyance parameter associated with the print medium information stored in advance, and the inserted print medium can be appropriately conveyed.

In addition to the conveyance parameter, the parameters set to the print job include whether white printing is included, a hiding rate in the white printing, a drying temperature after the white printing, a drying temperature in color printing, and a tension applied to the print medium. The parameters set to the print job can include an ink type to be used and a color profile type used in color matching. These parameters are merely examples, and the present exemplary embodiment is not limited thereto. In a case where the same print medium inserted into the image forming apparatus 100 is not included in a list display, a print medium similar to the inserted print medium in physical characteristic or feature is selected. The physical characteristic indicates a kind of print medium material (e.g., coated paper, fine quality paper, and film), and a thickness, a width, and a grammage of the print medium.

In step S303, data to be printed (multi-valued white image data and CMYK image data), a medium to be printed thereon, or a print job with a print setting described therein is set. In addition, the processing performed in steps S302 and S303 is executed by a user operating the information processing apparatus 211 connected to the image forming apparatus 100. The generated print job is transmitted to the image forming apparatus 100.

In step S304, the control unit 204 of the image forming apparatus 100 acquires print setting information including the print job set by the user of the image forming apparatus 100. The control unit 204 analyzes the print job included in the print setting information.

In step S305, before starting the printing, the control unit 204 of the image forming apparatus 100 determines whether the print medium designated by the print job coincides with the print medium inserted into the image forming apparatus 100.

In a case where the print medium designated by the print job does not coincide with the print medium inserted into the image forming apparatus 100 (NO in step S305), the processing proceeds to step S306. In step S306, the control unit 204 notifies the user that printing cannot be started.

In a case where the print medium designated in the print job coincides with the print medium inserted into the image forming apparatus 100 (YES in step S305), the processing proceeds to step S307. In step S307, the control unit 204 determines whether all the print settings to be used for printing have been completed. In step S307, in a case where it is determined that the print settings to be used for printing have not been completed (NO in step S307), the processing proceeds to step S308. In step S308, the control unit 204 notifies the user that the print settings have not been completed. In a case where it is determined that the print settings required for printing have been completed (YES in step S307), the processing proceeds to step S309. In step S309, the control unit 204 performs raster image processor (RIP) processing on the print image data designated in the print job.

The RIP processing can convert vector image data, which is image data described in commands, into raster image data, which is a group of print pixels. There is a certain kind of RIP processing including a color conversion function to convert the color of the print data. In step S310, the control unit 204 performs printing of the print image data generated by the RIP processing. The control unit 204 then ends the processing of this flowchart.

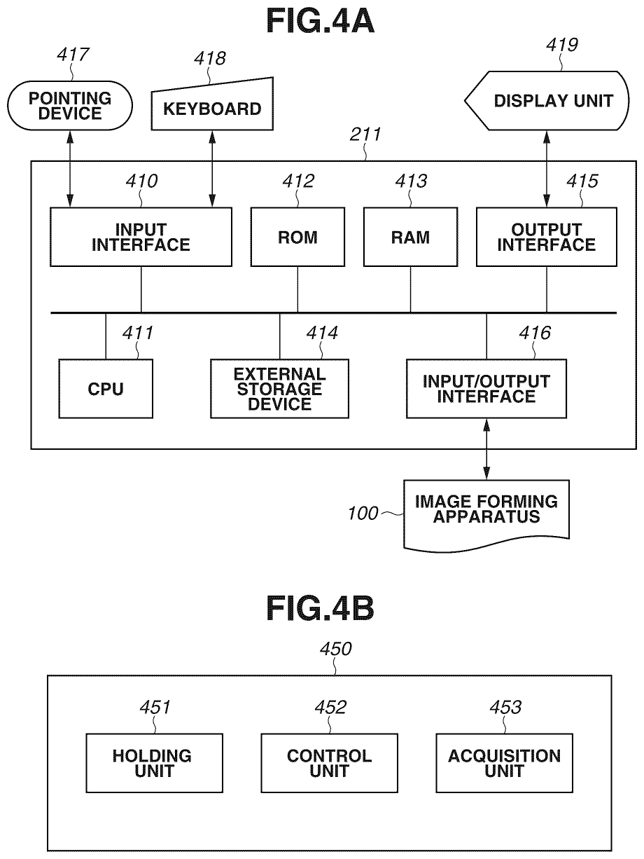

FIG. 4A is a block diagram illustrating a hardware configuration of the information processing apparatus 211 according to the present exemplary embodiment. The information processing apparatus 211 includes an input interface 410, a CPU 411, a read only memory (ROM) 412, a RAM 413, an external storage device 414, an output interface 415, and an input/output interface 416. Input devices, such as a keyboard 418 and a pointing device 417, are connected to the input interface 410, and a display device, such as a display unit 419, is connected to the output interface 415.

The CPU 411 is a control unit for controlling the information processing apparatus 211, and reads a program stored in the ROM 412 or the external storage device 414 into a work area of the RAM 413 and executes the program. The ROM 412 stores an initialization program. The external storage device 414 stores a program related to an application described below, an operating system (OS), and various kinds of data in addition thereto. The RAM 413 is a work memory when the CPU 411 executes a program.

The programs executed by the information processing apparatus 211 include application programs, such as a print layout application 450. Details of the print layout application 450 will be described below. In the printing system according to the present exemplary embodiment, the CPU 411 reads a program stored in the ROM 412 or the external storage device 414, to execute processing described in the program based on the procedures of flowcharts described below. With this operation, the information processing apparatus 211 implements various kinds of functions described below.

The image forming apparatus 100 is connected to the information processing apparatus 211 via the input/output interface 416. A plurality of the image forming apparatuses 100 can be connected to the information processing apparatus 211. In the present exemplary embodiment, the information processing apparatus 211 and the image forming apparatus 100 are separate from each other, but in another exemplary embodiment, these apparatuses can be configured as a single apparatus. A plurality of the information processing apparatuses 211 can also be connected to the image forming apparatus 100.

FIG. 4B is a block diagram illustrating a software configuration of the print layout application 450. A holding unit 451 is a functional unit for holding information of data and the like to be used for various kinds of controls of the print layout application 450. A control unit 452 is a functional unit for executing various kinds of controls of the print layout application 450. An acquisition unit 453 is a functional unit for acquiring image data registered to an artwork or the print setting information, such as a white hiding rate, set by a user.

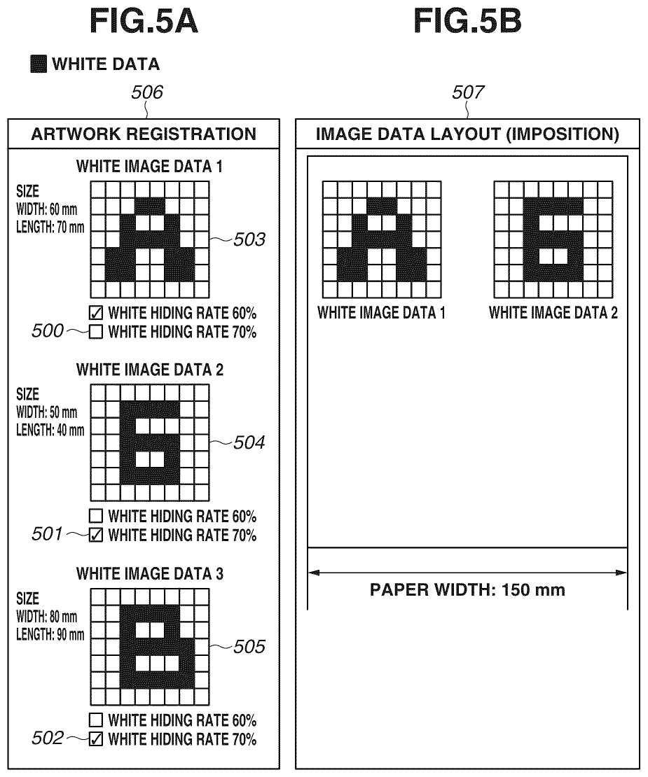

A setting method of the print setting on the white image data by the print layout application 450 will now be described. FIGS. 5A and 5B are diagrams each illustrating a UI screen used for performing a registration of artwork image data, a white hiding rate setting, and an image layout (imposition) in the print layout application 450. As illustrated in FIG. 5A, a user selects first a portable document format (PDF) file to be a print target candidate on an artwork registration screen 506. As a selection method, the user can drag and drop the PDF file onto the artwork registration screen 506, or can select a target PDF file from a folder. The print target PDF file includes white image data and CMYK color image data each serving as the data on a different layer, and information of the white image data is registered therefrom onto the artwork registration screen 506. In the present exemplary embodiment, an example is illustrated in which three pieces of image data including white image data 1 503, white image data 2 504, and white image data 3 505 are registered onto the artwork registration screen 506. In FIG. 5A, thumbnail images of pieces of white image data are displayed, but only file names of original PDF files of the pieces of white image data may be displayed. In FIG. 5A, sizes of the pieces of white image data are displayed, but this display is not required.

The white image data 1 503, the white image data 2 504, and the white image data 3 505 are respectively provided with check boxes 500, 501, and 502 used for designating whether to set the white hiding rate to 70% or 60%. FIG. 5A illustrates an example in which a user sets a white hiding rate 60% to the white image data 1 503, and a white hiding rate 70% to the white image data 2 504 and the white image data 3 505. The setting method of the white hiding rate is not limited to the above-described method, and a check box to which another white hiding rate, such as 80%, can be set can be prepared, or a field to which a numeral indicating a white hiding rate can be directly entered can also be prepared.

The white hiding rate is referred to as a print setting value for performing control such that a predetermined ratio of light can be optically transmitted in an area (pixels) having a maximum density (255), by performing printing on a transparent medium (e.g., transparent film) based on the white image data with a white hiding rate set therein. For example, when 70% is set as a white hiding rate, an ink application amount on the pixel having a value of 255 is adjusted based on the set white hiding rate, and the white printing is performed such that light of 30% can be transmitted therethrough. In an area with another density (e.g., value of 128), the transmitting light amount and the white hiding rate do not have a linear relationship, but as the white hiding rate increases, the amount of transmitting light decreases.

FIG. 5B illustrates a layout setting screen 507 used for setting a layout (imposition) of the white image data registered to the artwork registration screen 506. A user selects white image data to be printed by, for example, a drag and drop operation to layout the selected white image data on the layout setting screen 507 in FIG. 5B. In FIG. 5B, two pieces of data, e.g., the white image data 1 503 and the white image data 2 504, are arranged side by side in a horizontal direction (direction intersecting with the print medium conveyance direction). In FIG. 5B, the paper width of the print medium set in the print layout application 450 is 150 mm and two pieces of the white image data can be arranged horizontally, thus only two pieces of white image data are arranged. If the paper width to be set is longer, more pieces of white image data can be arranged. In FIG. 5B, the example in which the plurality of pieces of white image data is arranged horizontally is illustrated, but a plurality of pieces of white image data can also be vertically arranged. This enables printing one or more pieces of the white image data arranged in the same page on the layout setting screen 507 on the print medium as a unit (one copy) by the image forming apparatus 100 by the number of copies set separately.

In the present exemplary embodiment, the print layout application 450 determines whether white image data with a different print setting value (white hiding rate) set is included in the pieces of white image data arranged on the layout setting screen 507. In a case where the print layout application 450 determines that the white image data with a different print setting value set is included, the print layout application 450 performs data conversion of at least one piece of white image data so that the plurality of pieces of white image data arranged on the layout setting screen 507 can be printed with a common white hiding rate setting. The print layout application 450 then transmits a print job including the data-converted white image data and the common setting value (white hiding rate) data to the image forming apparatus 100.

In the image forming apparatus 100 according to the present exemplary embodiment, a plurality of pieces of white image data cannot be printed at the same time in a case where the white hiding rates are different (i.e., not common white hiding rate) since a different conveyance speed is set for each white hiding rate. This is because the time during when the print medium after printing passes under the drying device 112 needs to be relatively long to secure long drying time since relatively much white ink is discharged onto the print medium in a case where a high white hiding rate is set on the white image data. As a result, in the case where the white hiding rate set on the white image data is high, the conveyance speed is set to be slow. When a relatively low white hiding rate is set on the white image data, not much white ink is discharged on the print medium, and thus long drying time does not need to be secured. As a result, in the case where the white hiding rate set on the white image data is low, a relatively fast conveyance speed is set. As described above, since the image forming apparatus 100 according to the present exemplary embodiment is configured to change the conveyance speed depending on the white hiding rate, the printing cannot be performed at the same time if the white hiding rates of the plurality of pieces of white image data are not set common.

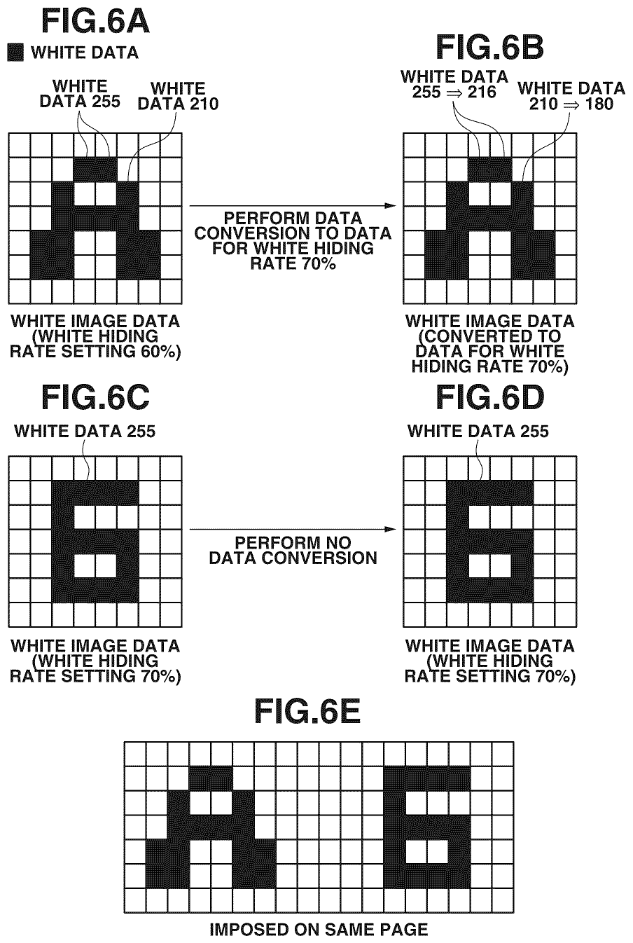

Next, a data conversion method of the white image data performed by the print layout application 450 will be described. FIGS. 6A to 6E are diagrams illustrating a data conversion method in a case where a plurality of pieces of white image data with different white hiding rates is laid out on a same page by the print layout application 450.

FIG. 6A illustrates white image data with a standard density (white hiding rate 60%) setting. As described above, the standard density (white hiding rate 60%) setting is referred to as a setting with which printing is performed such that the white hiding rate becomes 60% in a case where the white data value is designated to be 255. FIG. 6C illustrates white image data with a high density (white hiding rate 70%) setting. As described above, the high density (white hiding rate 70%) setting is referred to as a setting with which printing is performed such that the white hiding rate becomes 70% in a case where the white data value is designated to be 255. Areas (pixels) expressed in black illustrate white data areas with a value of, for example, 255 or 210.

In the present exemplary embodiment, the data conversion of a part of the pieces of white image data arranged on the layout setting screen 507 is performed so that the pieces of white image data can be printed out together with a common white hiding rate. More specifically, the data conversion is performed on the part of the pieces of white image data such that the printing can be performed with the highest white hiding rate as a common white hiding rate from among the white hiding rates set on the plurality of pieces of white image data arranged on the layout setting screen 507. Thus, in the present exemplary embodiment, a data conversion is performed on the white image with the white hiding rate 60% illustrated in FIG. 6A, and no data conversion is performed on the white image data with the white hiding rate 70% illustrated in FIG. 6C. The white image data illustrated in FIG. 6B is data obtained by converting the white image data with the white hiding rate 60% illustrated in FIG. 6A to the data with the white hiding rate 70%. In this data conversion, the print layout application 450 performs data conversion by using the following conversion formula (1), when data for the white hiding rate 70% is Y and data for the white hiding rate 60% is X.

$$Y = X \times 6 / 7 \qquad ( 1 )$$

In FIG. 6A for example, in a case where a value of 255 is designated for a certain pixel, the value becomes 216 (rounded to the first decimal place) in the converted data in FIG. 6C by the calculation using the above-described conversion formula (1). In FIG. 6A, in a case where a value of 210 is designated for a certain pixel, the value becomes 180 for the pixel in the converted data in FIG. 6C by the calculation using the above-described conversion formula (1). In addition, the data conversion formula in the present exemplary embodiment simply performs conversion using a linear formula of “Y=X×6/7”, but a quadric formula or a cubic formula can also be used depending on the characteristics of the image forming apparatus 100. The handling of decimal points can also be a rounding up, a rounding down, or the like, and is not limited to the above-described conversion formula (1).

In this way, in the case where the data conversion of all the pixels is performed using the conversion formula (1) and the printing is performed with the white hiding rate 70% setting, the print product similar to that printed with the white hiding rate 60% setting is obtained. No data conversion is performed as in FIG. 6D on the white image data with the white hiding rate set to 70% as in FIG. 6C, and the data registered to the print layout application 450 is used as is. After the white image data is generated as illustrated in FIGS. 6B and 6D, the print layout application 450 lays out (imposes) the plurality of pieces of white image data on a same sheet (page) as illustrated in FIG. 6E, and transmits the laid out data to the image forming apparatus 100. Thus, printing is performed.

The above description is provided of the data conversion when the settable white hiding rates are 60% and 70%. In the present exemplary embodiment, the data conversion is performed on a part of the pieces of white image data such that the printing can be performed with the highest white hiding rate as a common white hiding rate from among the white hiding rates set to the plurality of pieces of white image data arranged on the layout setting screen 507. Thus, in a case where the settable white hiding rates are, for example, 60%, 70%, and 80%, and when the hiding rates of the registered pieces of white image data are 60% and 70%, the white image data with the white hiding rate 60% is converted into the data for 70%. No data conversion is performed on the white image data with the white hiding rate 70%.

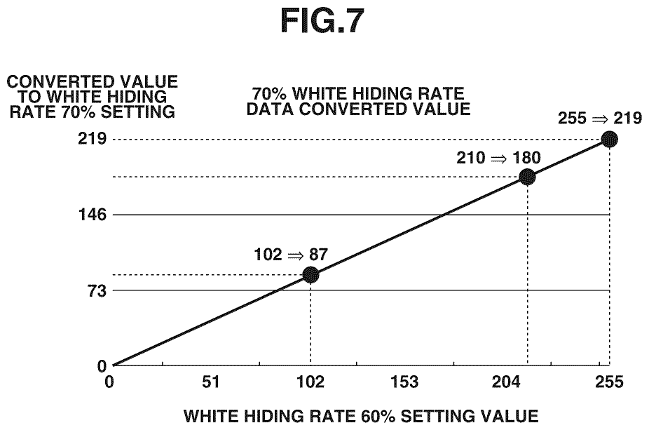

FIG. 7 is a graph illustrating a relationship when the value of the white image data with the white hiding rate 60% is converted into the value of the white image data for the white hiding rate 70% using the above-described conversion formula (1) according to the present exemplary embodiment. As described above, the conversion formula (1) performs calculation (conversion) using the formula “Y (data for white hiding rate 70%)=X (white hiding rate 60% data)×6/7”. For example, when a value of 255 in the white image data with the white hiding rate 60% set is converted into data for the white hiding rate 70%, the value becomes 219. When a value of 210 in the white image data with the white hiding rate 60% set is converted into data for the white hiding rate 70%, the value becomes 180. When a value of 102 in the white image data with the white hiding rate 60% set is converted into data for the white hiding rate 70%, the value becomes 87. The above-described conversion formula (1) in the present exemplary embodiment is “(data for white hiding rate 70%)=(white hiding rate 60% data)×6/7”. The conversion formula is not limited thereto, and various types of conversion formulas can be applied thereto depending on the characteristics of the image forming apparatus 100. In the present exemplary embodiment, the value after the conversion is determined by the calculation using the conversion formula, but the value after the conversion can be determined by, for example, holding relationships of values between before and after the conversion in the holding unit 451 of the print layout application 450 as a table and referring to the table.

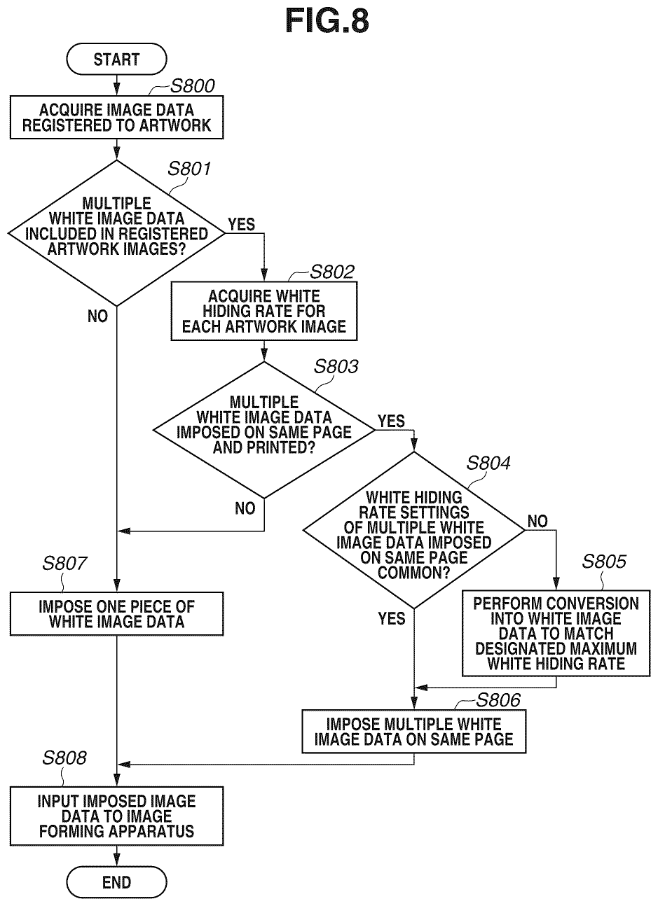

FIG. 8 is a flowchart illustrating a procedure related to the layout (imposition) processing performed by the print layout application 450 according to the present exemplary embodiment. In the present exemplary embodiment, data of a part of the pieces of white image data is converted with the highest white hiding rate as a common white hiding rate from among the white hiding rates set on the plurality of pieces of white image data registered to the print layout application 450.

In step S800, the acquisition unit 453 of the print layout application 450 acquires one or more pieces of image data registered to the artwork by a user. In step S801, the control unit 452 of the print layout application 450 determines whether a plurality of pieces of white image data is included in the pieces of image data registered to the artwork. In step S801, in a case where the control unit 452 determines that a plurality of the pieces of white image data is included (YES in step S801), the processing proceeds to step S802. In step S802, the acquisition unit 453 of the print layout application 450 receives a designation of a white hiding rate for each image registered in the artwork, and acquires information of the designated hiding rate. In the present exemplary embodiment, the method of designating the white hiding rate is as described above with reference to FIGS. 5A and 5B.

In step S803, the control unit 452 of the print layout application 450 determines whether a plurality of pieces of white image data laid out (imposed) on a same page is present. In step S803, in a case where the control unit 452 determines that the plurality of pieces of white image data is laid out on a same page (YES in step S803), the processing proceeds to step S804. In step S804, the control unit 452 of the print layout application 450 determines whether the white hiding rate settings for the plurality of pieces of white image data laid out on the same page are common. In the present exemplary embodiment, the settable white hiding rate settings are the high density white hiding rate (white hiding rate 70%) and the standard white hiding rate (white hiding rate 60%), and thus the control unit 452 determines whether the settings of the high density white hiding rate (white hiding rate 70%) and the standard white hiding rate (white hiding rate 60%) are mixed. The settings of the white hiding rates are not limited thereto, and, for example, a plurality of settings, such as a low white hiding rate (white hiding rate 50%), and an ultra-high density white hiding rate (white hiding rate 80%) can be made.

In step S804, in a case where the control unit 452 of the print layout application 450 determines that the white hiding rates of the plurality of pieces of white image data are not common (NO in step S804), the processing proceeds to step S805. In step S805, the print layout application 450 performs no data conversion on the white image data with the maximum white hiding rate setting, which is the white hiding rate 70% in the present exemplary embodiment, from among the set white hiding rates. In a case of the white image data with other white hiding rates, one of which is the white hiding rate 60% in the present exemplary embodiment, the white image data is converted to match the setting of the set maximum white hiding rate. Thereafter, the processing proceeds to step S806.

In step S804, in a case where the control unit 452 of the print layout application 450 determines that the white hiding rates set on the plurality of pieces of white image data are common (YES in step S804), the processing proceeds to step S806. In step S806, the print layout application 450 lays out (imposes) the plurality of pieces of white image data on the same page to generate the laid out image data. In step S806, after the layout on the same page is performed to generate the image data, the processing proceeds to step S808.

Returning to step S801, if the control unit 452 determines that the plurality of pieces of white image data is not included (NO in step S801), the processing proceeds to step S807. In step S807, the print layout application 450 lays out the one piece of white image data on the page to generate image data.

In step S808, the control unit 452 of the print layout application 450 transmits the image data including the white image data laid out on the page together with information (ticket) related to the print setting including the white hiding rate to the image forming apparatus 100 via the input/output interface 416. In the present exemplary embodiment, the print setting information related to the white hiding rate set by the print layout application 450 is transmitted to the image forming apparatus 100 in a form of a ticket, and the image forming apparatus 100 performs printing with the received hiding rate. The setting of the hiding rate is not limited thereto. A user can input the setting of the hiding rate via the UI operation panel 101 of the image forming apparatus 100 before the image forming apparatus 100 starts printing. In this case, the print setting information related to the white hiding rate may not be transmitted from the information processing apparatus 211 to the image forming apparatus 100.

The image forming apparatus 100 performs printing based on the received image data and the print setting. In the present exemplary embodiment, the white image data is described as an example, but actual image data can include CMYK data, other spot color data, or attribute data required for printing, in addition to the white image data.

As described above, according to the present exemplary embodiment, the data conversion of a part of the pieces of white image data is performed such that the printing can be performed with the highest white hiding rate as the common white hiding rate from among the white hiding rates set for the plurality of pieces of white image data registered to the print layout application 450. As such, even in the case where the printing is performed based on the pieces of image data with different print settings, the printing can be appropriately performed.

Next, a second exemplary embodiment according to the present disclosure will be described. In the first exemplary embodiment, the printing can be performed with the common white hiding rate, by the print layout application 450 converting a part of the pieces of white image data, in the case where the plurality of white hiding rates is set to the pieces of white image data registered to the print layout application 450. In the second exemplary embodiment, the printing can be performed with a common white hiding rate by the image forming apparatus 100 converting a part of the pieces of white image data in the case where the plurality of white hiding rates is set to the pieces of white image data registered to the print layout application 450. In the description below, the same components as those in the first exemplary embodiment are assigned the same symbols, and the descriptions thereof are omitted.

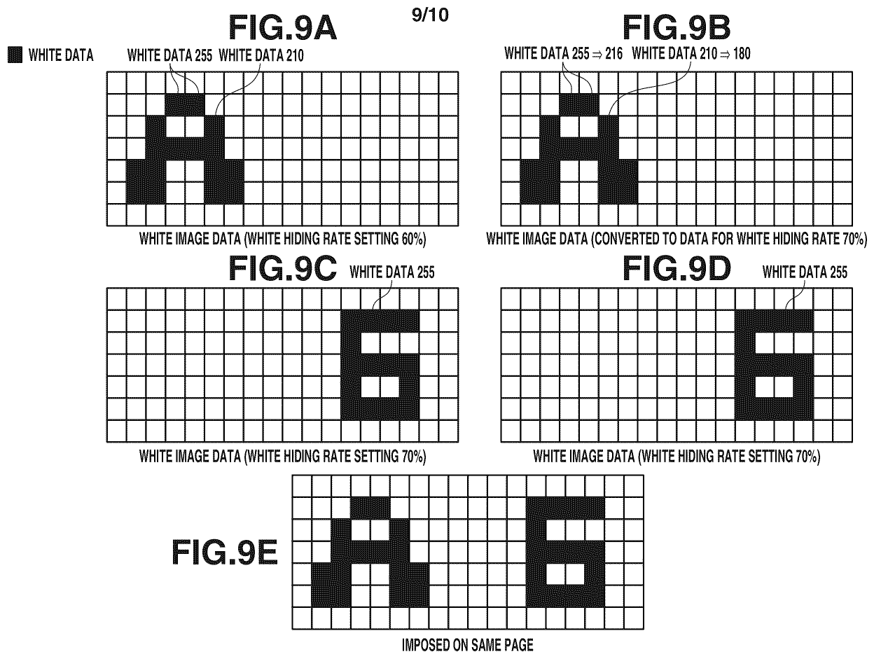

FIGS. 9A to 9E are diagrams illustrating a data conversion method and an imposition method in a case where pieces of white image data with different white hiding rate settings are laid out (imposed) on a same page in the image forming apparatus 100. FIG. 9A illustrates white image data with the standard density (white hiding rate 60%) setting. The standard density (white hiding rate 60%) setting is referred to as a setting with which printing is performed such that the white hiding rate becomes 60% in a case where the value of the white data is set to 255 as described above. FIG. 9C illustrates white image data with the high density (white hiding rate 70%) setting. The high density (white hiding rate 70%) setting is referred to as a setting with which printing is performed such that the white hiding rate becomes 70%, in a case where the value of the white data is set to 255 as described above.

FIGS. 9A and 9C illustrate the white image data with the white hiding rate 60% setting, and the white image data with the white hiding rate 70% setting, respectively. Each data is arranged on a same size sheet, and transmitted from the information processing apparatus 211 to the image forming apparatus 100. In the present exemplary embodiment, an example in which the high density (white hiding rate 70%) becomes the maximum white hiding rate is illustrated, and two types of the white image data illustrated FIG. 9A and FIG. 9C are transmitted (input) to the image forming apparatus 100. In the image forming apparatus 100, the white image data can be input to the image data for printing as separate two types of spot data different from the CMYK data. Alternatively, the white image data can be input to the image data for printing as separate spot color data files different from the CMYK data.

The image forming apparatus 100 performs data conversion of the input white image with the white hiding rate 60% illustrated in FIG. 9A. FIG. 9B is data obtained by converting the white image data in FIG. 9A into data with the white hiding rate 70%. This conversion method is similar to that described in the first exemplary embodiment. More specifically, the image forming apparatus 100 performs data conversion using “Y=X×6/7”, when Y is data for the white hiding rate 70% and X is data for the white hiding rate 60%. In the present exemplary embodiment, the image forming apparatus 100 performs data conversion of all the pixels designated as the white image data by using the above-described conversion formula (1). For example, in a case where a value of 255 is designated for a certain pixel in the white image data in FIG. 9A, the value of the corresponding pixel becomes 216 (rounded to the first decimal place) as in FIG. 9B, as calculated using the above-described conversion formula (1). In a case where a value of 210 is designated in FIG. 9A, the value of the corresponding pixel becomes 180 in FIG. 9B as calculated using the above-described conversion formula (1). While the data conversion formula in the present exemplary embodiment simply performs conversion using the linear formula of “Y=X×6/7”, a quadric formula or a cubic formula can also be used depending on the characteristics of the image forming apparatus 100. The handling of decimal points can be rounding up, rounding down, or the like, and is not limited to the above-described conversion formula (1).

Even in the case where the printing is performed with the white hiding rate 70% setting, the image forming apparatus 100 can obtain the printing result similar to the case where the printing is performed with the white hiding rate 60% setting by performing printing after performing the data conversion of all the pixels using the above-described conversion formula (1).

Since FIG. 9C illustrates the white image data with the white hiding rate 70%, the registered data is used as is without being subjected to the data conversion as illustrated in FIG. 9D. The image forming apparatus 100 generates the two pieces of white image data in FIGS. 9B and 9D, performs a layout (imposition) on a same page as illustrated in FIG. 9E, and performs printing based on the imposed data.

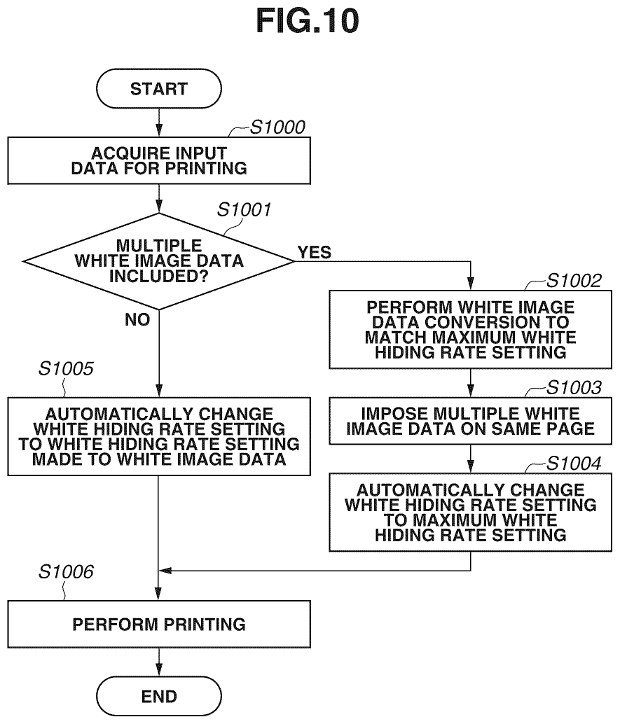

FIG. 10 is a flowchart illustrating a print control procedure of converting a part of a plurality of pieces of white image data input in the image forming apparatus 100 to match the maximum white hiding rate in the image forming apparatus 100, and printing the white image data.

In step S1000, the image forming apparatus 100 acquires image data for printing transmitted (input) to the image forming apparatus 100. In step S1001, the image forming apparatus 100 determines whether a plurality of pieces of white image data is included based on the input image data. In the example of the present exemplary embodiment, the high density white hiding rate (white hiding rate 70%) data and the standard white hiding rate (white hiding rate 60%) data, which are different from each other, are input as the different white image data as described with reference to FIGS. 9A to 9E. In step S1001, in a case where the image forming apparatus 100 determines that a plurality of the pieces of white image data is included (YES in step S1001), the processing proceeds to step S1002.

In step S1002, the image forming apparatus 100 does not perform data conversion of the white image data with the maximum white hiding rate setting, which is the white hiding rate 70% in the example of the present exemplary embodiment. The image forming apparatus 100 does perform, in a case of the white image data with other white hiding rates (60% in the example of the present exemplary embodiment), white image data conversion to match the setting of the maximum white hiding rate. After performing the data conversion of the white image data in step S1002, the processing proceeds to step S1003. In step S1003, the image forming apparatus 100 performs layout (imposition) of the plurality of pieces of white image data on a same page.

After the layout is performed in step S1003, in step S1004, the image forming apparatus 100 automatically changes the white hiding rate setting in the image forming apparatus 100 to the maximum white hiding rate, which is the white hiding rate 70% in the example of the present exemplary embodiment, from among the hiding rates set to the plurality of pieces of white image data. In a case where the image forming apparatus 100 determines that a plurality of pieces of white image data input in step S1001 is not included (NO in step S1001), the processing proceeds to step S1005. In step S1005, the image forming apparatus 100 automatically changes the setting of the white hiding rate to the white hiding rate set to the input white image data.

In the present exemplary embodiment, the white hiding rate setting can also be input by a user via the UI operation panel 101 of the image forming apparatus 100 before the image forming apparatus 100 starts printing.

In step S1006, the image forming apparatus 100 performs printing based on the received image data and the set print setting (white hiding rate).

As described above, according to the present exemplary embodiment, the image forming apparatus 100 performs data conversion of a part of the pieces of white image data such that printing can be performed with the maximum white hiding rate as a common white hiding rate from among the set white hiding rates. Thus, even in the case where the printing is performed based on the pieces of image data with different print settings, the printing can be appropriately performed.

The exemplary embodiments of the present disclosure can be implemented by executing the following processing. That is, a recording medium recording a program code of software to implement the functions of the above-described exemplary embodiments is supplied to a system or an apparatus, and a computer (CPU or micro processing unit (MPU)) of the system or the apparatus reads out and executes the program code. In this case, the program code itself read from the recording medium implements the functions of each of the exemplary embodiments described above, and the recording medium storing the program code configures the present disclosure.

Examples of the recording medium for supplying the program code include a flexible disk, a hard disk, an optical disk, a magneto-optical disk, a compact disk (CD)-ROM, a CD-recordable (R), a magnetic tape, a nonvolatile memory card, a ROM, and a digital versatile disk (DVD).

The present disclosure also includes a case where the functions according to the exemplary embodiments described above can be implemented by executing the program code read by the computer, as well as by an operating system (OS) or the like operating on the computer executing a part of or all of the actual processing based on the instructions given by the program code.

The present disclosure also includes a case where, after a program code read out from a storage medium is written into a memory of a function expansion board added to a commuter or a function expansion unit connected to a computer, a CPU or the like included in the function expansion board or the function expansion unit executes a part of or all of the actual processing to implement the functions of the above-described exemplary embodiments based on the instructions of the program code.

Within the range of the present disclosure, any combination of the exemplary embodiments, any modification of the components in the exemplary embodiments, or any elimination of the components are possible in the present disclosure.

According to the present disclosure, the printing can be appropriately performed even in a case where printing is performed based on pieces of image data different in print setting.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-162671, filed Sep. 26, 2023, which is hereby incorporated by reference herein in its entirety.

What is claimed is:

1. An information processing apparatus connected to an image forming apparatus, the information processing apparatus comprising:
a determination unit configured to determine whether pieces of setting information respectively set to a plurality of pieces of image data included in a same page to be printed by the image forming apparatus are common; and
a control unit configured to, in a case where the determination unit determines that the pieces of setting information respectively set to the plurality of pieces of image data are not common, convert at least a part of the pieces of image data in the plurality of pieces of image data.

2. The information processing apparatus according to claim 1, wherein the control unit is configured to convert a value designated on a pixel included in the part of the pieces of image data.

3. The information processing apparatus according to claim 2, wherein the control unit is configured to convert the value designated on the pixel using a conversion formula.

4. The information processing apparatus according to claim 3, wherein the conversion formula is a linear formula.

5. The information processing apparatus according to claim 1, wherein the setting information is a hiding rate for controlling an amount of light transmitted to a print medium on which printing is performed based on the image data.

6. The information processing apparatus according to claim 5, wherein the control unit is configured to convert the part of the pieces of image data based on a maximum hiding rate from among the hiding rates respectively set to the plurality of pieces of image data.

7. The information processing apparatus according to claim 6, wherein the part of the pieces of image data is image data other than image data set with the maximum hiding rate.

8. The information processing apparatus according to claim 1, wherein the image data is image data for performing printing with a spot color ink.

9. The information processing apparatus according to claim 1, wherein the control unit is configured to display a screen enabling a user to set the pieces of setting information respectively to the plurality of the pieces of image data.

10. The information processing apparatus according to claim 1, wherein the image forming apparatus is configured to vary a conveyance speed based on the set setting information.

11. An information processing method for processing image data to be printed by an image forming apparatus, the information processing method comprising:
determining whether pieces of setting information respectively set to a plurality of pieces of image data included in a same page to be printed by the image forming apparatus are common; and
converting, in a case where the pieces of setting information respectively set to the plurality of pieces of image data are determined to be not common, at least a part of the pieces of image data in the plurality of pieces of image data.

12. A non-transitory computer-readable storage medium storing computer-executable instructions that, when executed by a computer, cause the computer to perform an information processing method, the information processing method comprising:
determining whether pieces of setting information respectively set to a plurality of pieces of image data included in a same page to be printed by an image forming apparatus are common; and
converting, in a case where the pieces of setting information respectively set to the plurality of pieces of image data are determined to be not common, at least a part of the pieces of image data in the plurality of pieces of image data.
